(19) United States
(12) Patent Application Publication
(10) Pub. No.: US 2004/0144696 A1
(43) Pub. Date: Jul. 29, 2004

(54) Valve device for use in sorting apparatus ejectors

(76) Inventor: Stewart Mills, Upminster (GB)

Correspondence Address: PARSONS HSUE & DE RUNTZ LLP, 655 MONTGOMERY STREET, SUITE 1800, SAN FRANCISCO, CA, 94111, US

(21) Appl. No.: 10/354,501

(22) Filed: Jan. 29, 2003

(51) Int. Cl. B07C 5/00; F16K 31/12

(52) U.S. Cl. 209/639; 251/50; 209/638

(57) ABSTRACT

A valve device is disclosed for controlling the delivery of gas from a pressurised source, suitable for use in a pneumatic ejector in sorting apparatus. The device comprises a housing defining a valve element chamber with an input for connection to a source of pressurised gas. A body in which at least one output duct is formed, has an end face in the chamber with a valve seat thereon surrounding the output duct or ducts. A valve element overlays the valve seat, and means are provided for moving the element between a closed position in engagement with the valve seat and an open position spaced from the valve seat. Additional abutment surfaces can be provided for engagement with the valve element on closure. At least one pocket is formed in one of the juxtaposed body end face and the valve element, which pocket forms a cushion of gas as the element moves towards its closed position. The pocket or pockets or additional pocket or pockets can be formed on one or more abutment surfaces spaced from the valve seat. Similar pockets can be formed on surfaces in juxtaposition to form a gas cushion on movement of the valve element to its open position.

### BACKGROUND TO THE INVENTION

This invention relates to valve devices for gas, and particularly to such devices associated with pneumatic ejectors for use in sorting apparatus. These ejectors are used in sorting apparatus in which material to be sorted is directed in a product stream following an aerial path, and certain material is removed from the stream by air pulses from the ejectors. Valve devices are used in the ejectors to control the delivery of air from a pressurised source to the ejector nozzle directed at a particular section of the product stream. An operating mechanism, normally comprising an electric circuit, acts to open the valve device selectively in response to a control signal to deliver a pulse of pressurised air to, and thus from the respective nozzle. As the demand for quality and dependability increases, so must the lifetime and reliability of the ejectors and the valve devices therein also improve.

Although described with reference to sorting apparatus, it will be recognised that valve devices of the invention will have application in other technical fields where the delivery of a gas under pressure calls for accurate and/or repeatable control.

Many current sorting apparatus using pneumatic ejectors grade particulate material according to its ability to reflect light. Typical such apparatus are described in U.S. Pat. Nos. 4,203,522; 4,513,868; and 4,699,273, the disclosures whereof are incorporated herein by reference. In apparatus disclosed in the '522 Patent detectors are responsive to light reflected from the particles and generate signals indicative of different qualities of the product. These signals are compared and analysed, to generate a comparison signal which can activate an ejector to remove the relevant particle from the product stream. An ejector in these apparatus will normally use an electrically actuated valve device such as a moving iron disc or plate valve to discharge pulses of pressurised air selectively to remove particles from its respective target area.

Air valves of various kinds have been developed based on piezoelectric actuators. Piezoelectric actuated valves are disclosed in U.S. Pat. Nos. 5,079,472 and 5,343,894, and Canadian Patent Specification No: 2 093 257, to which reference is directed. Reference is also directed to European Patent No: 0 795 099 and U.S. Pat. No. 5,628,411.

### SUMMARY OF THE INVENTION

The present invention is directed at a valve device for controlling the delivery of gas from a pressurised source which would be suitable for use in a pneumatic ejector in sorting apparatus of the type described above. The device comprises a housing defining a valve element chamber with an input thereto, and a body in which at least one output duct is formed, the body having an end face in the chamber with a valve seat thereon surrounding the output duct or ducts. A valve element overlays the valve seat; and means are provided for moving the element between a closed position in engagement with the valve seat and an open position spaced from the valve seat. Additional abutment surfaces can be provided for engagement with the valve element on closure. At least one pocket is formed in one of the juxtaposed body end face and the valve element, which pocket forms a cushion of gas as the element moves towards its closed position.

In a variant of the invention the pocket or pockets or additional pocket or pockets can be formed on one or more abutment surfaces spaced from the valve seat. It will be appreciated of course that the pocket or pockets can as easily be formed on the respective valve element surface in juxtaposition to the abutment surface or surfaces, as on the abutment surface or surfaces themselves.

In the use of a valve device of the invention the open position of the valve element is normally defined by its engagement with a stop or stops commonly defined by the means effecting movement of the element. This engagement will itself cause wear on the valve element and the stop, and this wear can also be reduced by forming one or more pockets in one or both of the respective juxtaposed surfaces of the valve element and stop or stops in the various embodiments of the invention. Thus, in accordance with a further variant of the invention the valve element engages a stop in its open position, and at least one pocket is formed in one of the juxtaposed surfaces of the stop and the valve element, which pocket forms a cushion of gas as the element moves towards its open position. The stop is normally aligned with the valve seat, with either a single pocket in similar alignment or a plurality of pockets arranged symmetrically relative thereto. The purpose of this alignment is of course to balance the forces acting on the valve element during its movement, and a stop and pocket arrangement may be located on the axis of that movement, or symmetrically relative thereto.

Each pocket in one or both of the juxtaposed faces of the valve components creates a volume into which gas is compressed as the valve closes. This generates a cushion or air brake which slows the impact between the valve element and the valve seat and/or abutments on closure and/or a stop on opening, thereby reducing the rate at which the valve components wear. Research indicates that the final closing movement of the valve element is slowed by the effect of the pocket or pockets, but that the slower impact speed does not substantially alter the time required to effectively close the valve. It follows that a similar effect can be achieved in the opening movement. Additional control of the movement of the valve element as it approaches the valve seat can be accomplished by including a bleed pathway from the, or at least one pocket. The pathway can be for example to the valve element chamber or the input thereto, or to the output duct or ducts or downstream thereof. Bleed pathways allow for some adjustment of the cushion effect independently of the valve closure.

The pocket or pockets forming the gas cushion as the valve closes or opens may take various forms, provided a pocket forms a closed or substantially closed volume relative to the surface in which it is formed. The simplest form of pocket is a recess with its open face at the surface, but a similar effect can be achieved with different forms. For example, the cross-section of a recess may vary; tapering towards the surface, or with its open face being of smaller area than the recess cross-section below. In another form, two or more open faces at the surface can communicate with a common space or chamber below the surface. This can serve to balance the effect.

In use of a valve device according to one embodiment of the invention, the input to the valve element chamber will normally be in substantially continuous communication with a source of gas under pressure. The valve element can be selectively withdrawn from the valve seat to admit pressurised gas thereinto. An electrical circuit is operable to selectively activate one or more electromotive devices to withdraw the valve element from the valve seat. Because the element itself is only a short distance from the valve seat in the open position, there is then a differential pressure which together with dynamic forces on the valve element caused by the gas flow therearound urges the element into engagement with the valve seat to close the output port. These forces are overcome by the opening force, but when the opening force is withdrawn the forces prevail to close the valve. Once closed the differential pressure between the input and output ports holds the element in the closed position.

The cross-section of the path of gas past the valve element in its open position and into the output port can be adjustable. In the preferred construction of the valve device the output port body is adjustable in the housing, or formed in a section of the housing which is secured by an adjustable mounting mechanism. Adjustment alters the position of the output port on the housing body and thereby relative to the valve element in the open position.

The preferred application of valve devices according to the invention is in pneumatic ejectors of the kind used in sorting apparatus. In such apparatus, the ejectors have not only to be reliable over many cycles of use, but have also to be operable at great speed and high frequency. For these reasons, the movement of the valve to open and close the output port has to be accomplished with minimum unnecessary movement and wear on the valve element and seat. The creation of gas or air cushions as provided by the invention in either or both of the opening and closing movements of the valve element can enable both wear of the valve elements and the valve movement to be minimised without adversely affecting performance.

It will be appreciated that the invention can be applied in situations in which a plurality of bodies have end faces with valve seats in a common valve element chamber. In one such arrangement a single valve element can overlay two or more valve seats, and be movable from its closed position in engagement with both valve seats to simultaneously expose the output ducts in both bodies to gas pressure in the valve inlet chamber. In another arrangement, a separate valve element may overlay each valve seat and be operable independently of the other element or elements.

### BRIEF DESCRIPTION OF THE DRAWINGS

Various features and advantages of the present invention will be apparent from the following description of preferred embodiments. Reference will be made to the accompanying schematic drawings in which the same reference numerals in all the Figures identify like components.

FIG. 1 illustrates diagrammatically the operation of a typical colour sorting apparatus;

FIG. 2 is a cross-sectional view illustrating the construction of a valve device according to the invention;

FIG. 3 is an enlarged view of Section A in FIG. 2;

FIG. 4 is a top perspective view of the valve seat in the valve device of FIG. 2;

FIG. 5 is an enlarged view of the juxtaposed valve components in the valve device of FIG. 2;

FIG. 6 is a view similar to that of FIG. 5 but showing a variation therefrom;

FIG. 7 is a view similar to that of FIG. 2, but showing one alternative embodiment of the invention; and

FIG. 8 is another view similar to that of FIG. 2, showing another alternative embodiment of the invention.

### DESCRIPTION OF PREFERRED EMBODIMENTS

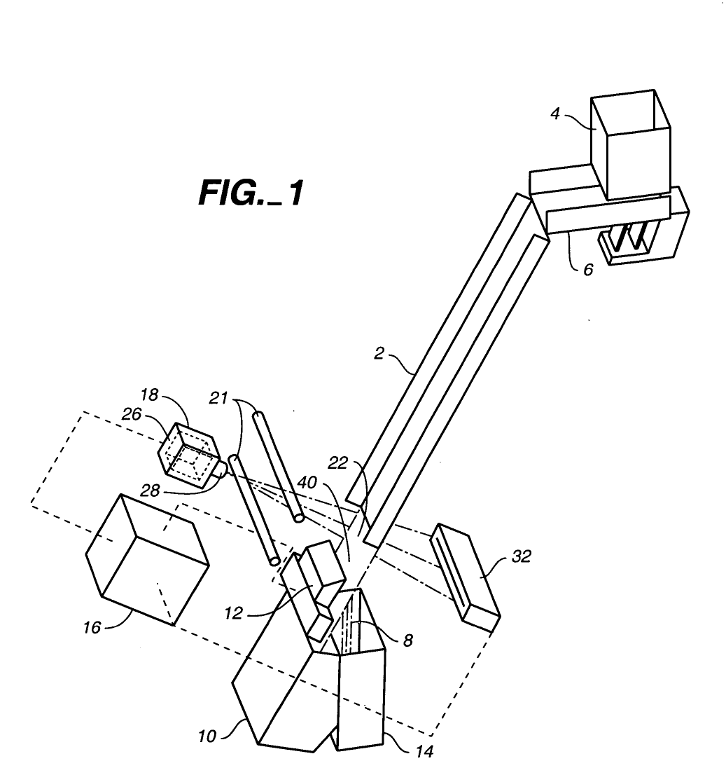

FIG. 1 illustrates a chute 2 to which particulate material is fed from a hopper 4 via a vibrator tray 6. The chute 2 directs material in a product stream to a receptacle 10. During its passage from the end of the chute 2 to the receptacle 10, the material is kept in the product stream solely by its own momentum. Ejectors are arranged in a battery 12 which extends over the width of the product stream, and are operable to remove particles from specific zones of the product stream by high pressure air jets. Removed particles 8 are directed towards a reject receptacle 14. Typically, the lateral width of the product stream is 20 cms, with for example, thirty-two ejector nozzles equally spaced thereover. The ejectors 12 are instructed by a computer or microprocessor 16, which itself receives input data from the scanning system 18 described below.

Reference numeral 22 indicates a region in the product stream where the product is scanned. Region 22 is illuminated by a light source 24, and particles in the region 22 reflect light which is received in the scanning assembly 18. The assembly 18 comprises a camera 26, lens 28, and the camera 26 includes a charge coupled device which monitors light received from particles in the product stream. The charge coupled device in the camera 26 is arranged to view the entire lateral dimension of the product stream. The apparatus has an illuminated background provided by a lamp element 32. Its brightness is normally adjustable to match good product.

The signals generated by the camera 26 are passed to a computer 16. If a particle is defective, then the computer 16 instructs an ejector in the battery 12 to remove that particle from the stream by the delivery of an air pulse to the appropriate section of the stream in the removal zone 40. Such removed particles are deflected from the path of the product stream into the reject receptacle 14.

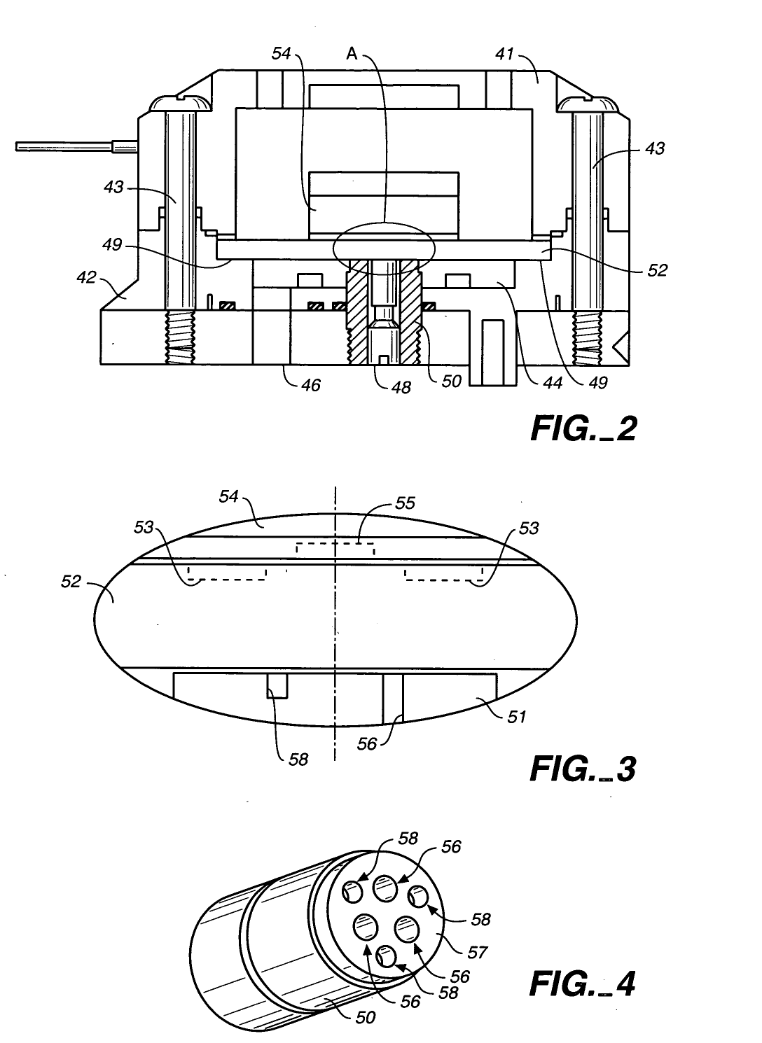

The ejectors in the array or battery 12 have nozzles directed towards particular target areas, and are connected to a source of air under pressure. Each ejector includes a valve device according to the invention, and FIGS. 2 to 5 illustrate the operation thereof. The valve device comprises a housing comprising two parts 41 and 42 held by screws 43 and defining a valve element chamber 44 which receives pressurised air from a source (not shown) through inlet port 46. The output port 48 from the chamber is connected to the chamber through an output duct body 50 upon the end face of which is a valve seat 51. The valve seat, as shown in FIG. 3, is closed by a valve plate 52. The plate 52 is formed in a magnetizable material, and is withdrawn from the valve seat 51 to open the valve by selective activation of the electromagnetic assembly indicated at 54.

FIG. 3 shows the engagement of the valve plate 52 with the valve seat 51 in rather more detail, and FIG. 4 shows the end face of the valve seat. As shown in FIG. 4, the seat has output ducts 56 through which air may be discharged, and three pockets in the form of recesses or closed volumes 58. Only one of each of these ducts and recesses is shown in FIGS. 2 and 3, which are of course cross-sectional views.

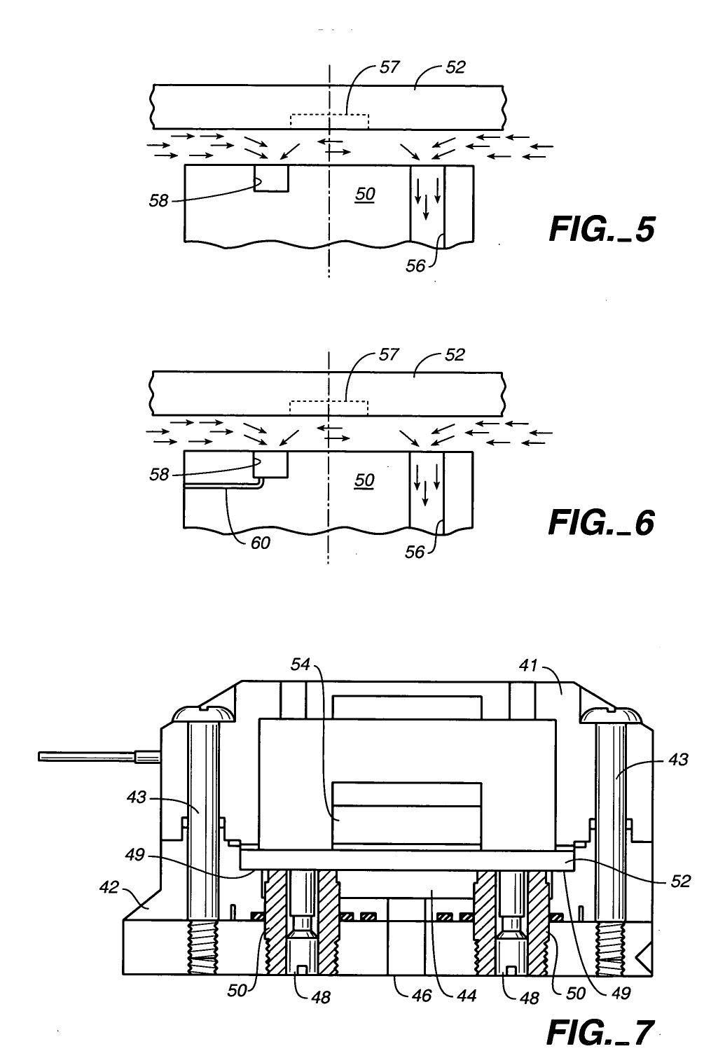

FIG. 5 shows in even more detail the juxtaposed valve components in their open position, with arrows indicating airflow therebetween. The air pressure above the valve plate 52 as shown will be at the inlet pressure. Air below the plate as shown and accelerating towards the outlet ducts 56 will be at a lower pressure. The pressure difference will of course be urging the plate towards the seat 51, but the valve is held open by the action of the electromagnetic assembly 54 holding the plate 52. When the coil assembly is deactivated, the pressure differential accelerates the plate towards the valve seat to close the valve. As it does so, while air in the output ducts 56 can freely escape, air in each recess or closed volume 58 is compressed. This creates a cushion which eventually resists the approach of the plate, with the consequent reduction in the rate at which the valve components and particularly the valve seat 50, wears.

In the variation shown in FIG. 6, the recess 58 in the valve seat 50 is formed with a bleed pathway 60. This pathway bleeds air back to the valve element chamber 44 but it may be directed to one of a number of different regions. The provision of such pathways can further smooth the closure of the valve plate 52 by reducing the potential for re-opening in response to the cushion effect.

As described above the invention is embodied in the deployment of pockets in the form of recesses in the face of the valve seat in juxtaposition to the valve element or plate as it moves to its closed position. It will though, be appreciated that a similar “cushion” effect can be achieved by the deployment of pockets in different locations. In one alternative pockets can be formed in the respective face of the valve element, as indicated in dotted outline at 57 in FIG. 5. Pockets may of course be formed in both juxtaposed faces. In another alternative, pockets may be formed in one or both juxtaposed faces not in the region of the valve seat, but on one or both of the valve element and the surface of an abutment spaced from the valve seat. In this alternative it is preferred to have a plurality of such abutments symmetrically arranged around the valve seat. Two such abutments are shown at 49 in FIG. 2.

There can also, as discussed above, be some benefit in creating a “cushion” effect as the valve element moves towards its open position as an alternative or in addition to creating the effect as the valve element closes. This can be accomplished by creating pockets indicated in dotted outline at 53 and 55 in FIG. 3 in the other face of the valve element 52 and/or the juxtaposed face of the electromagnetic assembly 54. Once again, pockets may be formed in both juxtaposed faces.

The invention has been described in the context of a valve device in which one or more output ducts are formed in a single body within the valve element chamber. However, it will be appreciated that more than one such body can be included in a single valve device with the respective output ports being directed to separate or common points of discharge. In this sense, and in a battery of ejectors in sorting apparatus of the kind referred to above, a plurality of ejector nozzles can receive pressurised air from the same chamber in which different output bodies are fitted, with independently operable valve elements. This is similar to the arrangement described and illustrated in FIG. 4 of European Patent No: 0 795 099 and U.S. Pat. No. 5,628,411, referred to above.

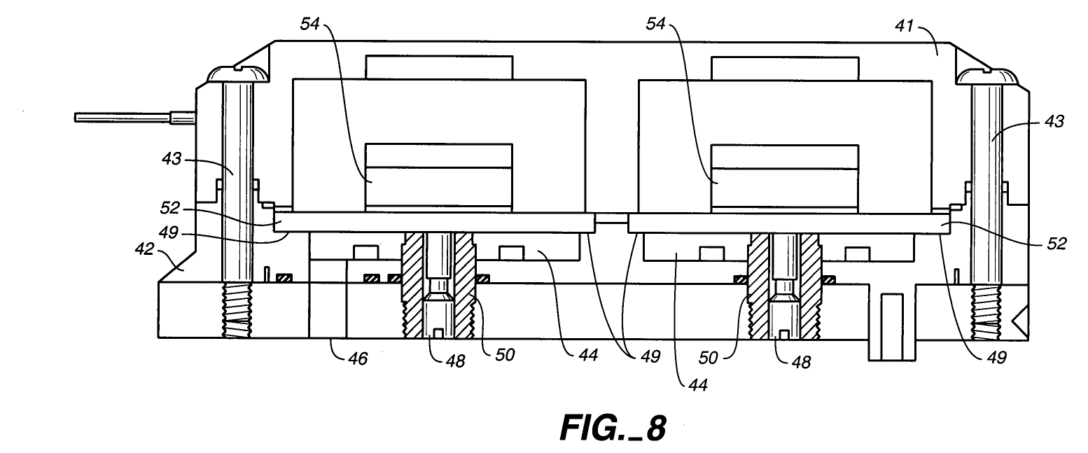

FIGS. 7 and 8 illustrate further embodiments of the invention in which a plurality of output ducts 50 are fitted in the lower part 42 of the housing. The bodies 50 project into a common valve inlet chamber 44, and upon the end face of each body is formed a valve seat 51 of the kind described above with reference to FIGS. 2 to 6. In FIG. 7, a single valve element 52 is shown overlaying two output duct bodies 50. In use, the valve element 52 is normally in its closed position in engagement with the valve seat (51) on both bodies 50. When the electromagnetic assembly 54 is activated to move it to its open position, it simultaneously exposes the output duct (56) in both bodies 50 to air pressure in the valve element chamber 44. When the valve element 52 is in its open position, the output ducts (56) deliver pressurised air to both output ports 48 which may be connected to the same or separate mechanisms as desired.

In FIG. 8 separate valve elements 52 overlay separate output duct bodies 50, and are movable by independently operable electromagnetic assemblies 54. However, the valve elements 52 are themselves disposed in a common valve element chamber 44. Thus, movement of either valve element 52 to its open position exposes the respective output duct or ducts (56) to the same air pressure in the valve element chamber.

In each of the embodiments illustrated in FIGS. 7 and 8, pockets are formed in one or more of the juxtaposed surfaces of the valve element and valve seat or abutment surface or surfaces 49 on the closure side, or the valve element and stop on the opening side, once again as described above with reference to FIGS. 2 to 6.

As noted above, ejector valves in sorting machines are designed to be reliable over many cycles of use, and their useful life is predominantly determined by wear on the valve seat. In tests it has been found that the useful life of a valve incorporating the present invention can be increased by a significant margin.

1. A valve device for controlling the delivery of gas from a pressurised source, comprising a housing defining a valve element chamber with an input thereto; a body in which at least one output duct is formed, the body having an end face in the chamber with a valve seat thereon surrounding the output duct or ducts; a valve element overlaying the valve seat; and means for moving the element between a closed position in engagement with the valve seat and an open position spaced from the valve seat; wherein at least one pocket is formed in one of the juxtaposed body end face and the valve element, which pocket forms a cushion of gas as the element moves towards the closed position.

2. A valve device according to claim 1 wherein said at least one pocket is arranged symmetrically relative to the output duct or ducts.

3. A valve device according to claim 1 wherein a plurality of pockets are arranged relative to the output duct or ducts.

4. A valve device according to claim 3 wherein each said pocket is in the form of a recess of circular cross-section.

5. A valve device according to claim 1 wherein said at least one pocket is in the form of a single annular recess extending around the output duct or ducts.

6. A valve device according to claim 1 wherein said at least one pocket is formed in the end face of the output duct body.

7. A valve device according to claim 1 wherein said at least one pocket is formed in the valve element.

8. A valve device according to claim 1 wherein a said at least one pocket is formed in each of the output duct body end face and valve element.

9. A valve device according to claim 8 wherein no pocket in the output duct body end face is in juxtaposition to a pocket in the valve element.

10. A valve device according to claim 1 wherein a plurality of output ducts are formed in the output duct body.

11. A valve device according to claim 1 wherein said at least one pocket is formed with a bleed pathway therefrom to provide controlled leakage of gas from the pocket.

12. A valve device according to claim 1 wherein the valve element comprises magnetic or magnetisable material, and the moving means comprises an electromagnet assembly for selectively displacing the valve element from the valve seat.

13. A valve device according to claim 1 wherein the valve element comprises a piezoelectric element normally in said closed position, and the moving means comprises a source of electric power and means for selectively connecting the power to the element to displace it from the valve seat.

14. A valve device according to claim 1 including a plurality of said bodies with a corresponding plurality of valve elements; and means for moving each valve element between closed and open positions relative to a given body.

15. A valve device according to claim 14 wherein the moving means are operable to move each valve element independently of the other valve elements.

16. A valve device according to claim 1 including a set of two or more said bodies, and wherein a single valve element is movable relative to said set of bodies between a closed position in engagement simultaneously with the valve seat on each said body and an open position spaced from said valve seats.

17. A valve device according to claim 16 including a plurality of said sets of bodies, with a single valve element movable as aforesaid relative to each set.

18. A valve device for controlling the delivery of gas from a pressurised source, comprising a housing defining a valve element chamber with an input thereto; a body in which at least one output duct is formed, the body having an end face in the chamber with a valve seat thereon surrounding the output duct or ducts; a valve element overlaying the valve seat; and means for moving the element between a closed position in engagement with the valve seat, and in juxtaposition with an abutment surface, and an open position spaced from the valve seat, wherein at least one pocket is formed in one of the juxtaposed abutment surface and the valve element, which pocket forms a cushion of gas as the element moves towards its closed position.

19. A valve device according to claim 18 including a plurality of said bodies with a corresponding plurality of valve elements; and means for moving each valve element between closed and open positions relative to a given body.

20. A valve device according to claim 19 wherein the moving means are operable to move each valve element independently of the other valve elements.

21. A valve device according to claim 18 including a set of two or more said bodies, and wherein a single valve element is movable relative to said set of bodies between a closed position in engagement simultaneously with the valve seat on each said body and an open position spaced from said valve seats.

22. A valve device according to claim 21 including a plurality of said sets of bodies, with a single valve element movable as aforesaid relative to each set.

23. A valve device according to claim 18 including a plurality of said abutment surfaces.

24. A valve device for controlling the delivery of gas from a pressurised source, comprising a housing defining a valve element chamber with an input thereto; a body in which at least one output duct is formed, the body having an end face in the chamber with a valve seat thereon surrounding the output duct or ducts; a valve element overlaying the valve seat; and means for moving the element between a closed position in engagement with the valve seat and an open position at which the valve element engages a stop, wherein at least one pocket is formed in one of the juxtaposed surfaces of the stop and the valve element, which pocket forms a cushion of gas as the element moves towards its open position.

25. A valve device according to claim 24 including a plurality of said bodies with a corresponding plurality of valve elements; and means for moving each valve element between closed and open positions relative to a given body.

26. A valve device according to claim 25 wherein the moving means are operable to move each valve element independently of the other valve elements.

27. A valve device according to claim 24 including a set of two or more said bodies, and wherein a single valve element is movable relative to said set of bodies between a closed position in engagement simultaneously with the valve seat on each said body and an open position spaced from said valve seats.

28. A valve device according to claim 27 including a plurality of said sets of bodies, with a single valve element movable as aforesaid relative to each set.

29. A valve device according to claim 24 wherein the stop is aligned with the valve seat, and wherein a single said pocket is aligned with the stop and the valve seat.

30. A valve device according to claim 24 wherein the stop is aligned with the valve seat, and wherein a plurality of said pockets are arranged symmetrically relative thereto.

31. A valve device for controlling the delivery of gas from a pressurised source, comprising a housing defining a valve element chamber with an input thereto; a body in which at least one output duct is formed, the body having an end face in the chamber with a valve seat thereon surrounding the output duct or ducts; a valve element overlaying the valve seat; and means for moving the element between a closed position in engagement with the valve seat and an open position spaced from the valve seat at which the valve element engages a stop, wherein at least one pocket is formed in one of the juxtaposed body end face and the valve element, which pocket forms a cushion of gas as the element moves towards its closed position, and wherein at least one pocket is formed in one of the juxtaposed surfaces of the stop and the valve element, which pocket forms a cushion of gas as the element moves towards its open position.

32. A valve device for controlling the delivery of gas from a pressurised source, comprising a housing defining a valve element chamber with an input thereto; a body in which at least one output duct is formed, the body having an end face in the chamber with a valve seat thereon surrounding the output duct or ducts; a valve element overlaying the valve seat; and means for moving the element between a closed position in engagement with the valve seat, and in juxtaposition with an abutment surface, and an open position spaced from the valve seat, at which the valve element engages a stop, wherein at least one pocket is formed in one of the juxtaposed abutment surface and the valve element, which pocket forms a cushion of gas as the element moves towards its closed position, and wherein at least one pocket is formed in one of the juxtaposed surfaces of the stop and the valve element, which pocket forms a cushion of gas as the element moves towards its open position.

33. A pneumatic ejector for sorting apparatus in which material to be sorted is directed in a stream following an aerial path, and certain material is removed from the stream by gas pulses from such ejectors, which ejector comprises a valve device according to claim 1, with the input to its valve element chamber coupled to a source of pressurised gas, and its output duct or ducts connecting to an ejector nozzle, the ejector including an electric circuit selectively operable to actuate the moving means to withdraw the valve element from the output duct or ducts to admit gas from the valve element chamber into the output duct or ducts and thence to the ejector nozzle.

34. A pneumatic ejector for sorting apparatus in which material to be sorted is directed in a stream following an aerial path, and certain material is removed from the stream by gas pulses from such ejectors, which ejector comprises a valve device according to claim 18, with the input to its valve element chamber coupled to a source of pressurised gas, and its output duct or ducts connecting to an ejector nozzle, the ejector including an electric circuit selectively operable to actuate the moving means to withdraw the valve element from the output duct or ducts to admit gas from the valve element chamber into the output duct or ducts and thence to the ejector nozzle.

35. A pneumatic ejector for sorting apparatus in which material to be sorted is directed in a stream following an aerial path, and certain material is removed from the stream by gas pulses from such ejectors, which ejector comprises a valve device according to claim 24, with the input to its valve element chamber coupled to a source of pressurised gas, and its output duct or ducts connecting to an ejector nozzle, the ejector including an electric circuit selectively operable to actuate the moving means to withdraw the valve element from the output duct or ducts to admit gas from the valve element chamber into the output duct or ducts and thence to the ejector nozzle.

36. A pneumatic ejector for sorting apparatus in which material to be sorted is directed in a stream following an aerial path, and certain material is removed from the stream by gas pulses from such ejectors, which ejector has a valve device comprising a housing defining a valve element chamber with an input thereto coupled to a source of pressurised gas; a body in which at least one output duct is formed, the body having an end face in the chamber with a valve seat thereon surrounding the output duct or ducts; a valve element overlaying the valve seat; and means for moving the element between a closed position in engagement with the valve seat, and in juxtaposition with an abutment surface, and an open position spaced from the valve seat, at which the valve element engages a stop, at least one pocket being formed in one of the juxtaposed abutment surface and the valve element, which pocket forms a cushion of gas as the element moves towards its closed position, and at least one pocket being formed in one of the juxtaposed surfaces of the stop and the valve element, which pocket forms a cushion of gas as the element moves towards its open position, and wherein an ejector nozzle is connected to the output duct or ducts, the ejector including an electric circuit selectively operable to actuate the moving means to withdraw the valve element from the output duct or ducts to admit gas from the valve element chamber into the output duct or ducts and thence to the ejector nozzle.

37. A pneumatic ejector for sorting apparatus in which material to be sorted is directed in a stream following an aerial path, and certain material is removed from the stream by gas pulses from such ejectors, which ejector has a valve device comprising a housing defining a valve element chamber with an input thereto coupled to a source of pressurised gas; a body in which at least one output duct is formed, the body having an end face in the chamber with a valve seat thereon surrounding the output duct or ducts; a valve element overlaying the valve seat; and means for moving the element between a closed position in engagement with the valve seat and an open position spaced from the valve seat at which the valve element engages a stop, at least one pocket being formed in one of the juxtaposed body end face and the valve element, which pocket forms a cushion of gas as the element moves towards its closed position, and at least one pocket being formed in one of the juxtaposed surfaces of the stop and the valve element, which pocket forms a cushion of gas as the element moves towards its open position, and wherein an ejector nozzle is connected to the output duct or ducts, the ejector including an electric circuit selectively operable to actuate the moving means to withdraw the valve element from the output duct or ducts to admit gas from the valve element chamber into the output duct or ducts and thence to the ejector nozzle.
